(19) United States
(12) Patent Application Publication
(10) Pub. No.: US 2025/0070237 A1
(43) Pub. Date: Feb. 27, 2025

(54) SOLID ELECTROLYTE CERAMIC AND SOLID-STATE BATTERY

(71) Applicant: Murata Manufacturing Co., Ltd., Nagaokakyo-shi, (JP)

(72) Inventors: Yusuke TAKARA, Nagaokakyo-shi, Kyoto-fu (JP); Ryohei TAKANO, Nagaokakyo-shi, Kyoto-fu (JP)

(21) Appl. No.: 18/944,177

(22) Filed: Nov. 12, 2024

Related U.S. Application Data
(63) Continuation of application No. PCT/JP2023/016828, filed on Apr. 28, 2023.

(30) Foreign Application Priority Data
May 17, 2022 (JP) 2022-080944

(51) Int. Cl. H01M 10/0562; H01M 10/0525

(52) U.S. Cl. CPC H01M 10/0562; H01M 10/0525; H01M 2300/0077

(57) ABSTRACT

A solid electrolyte ceramic having a chemical composition represented by a specific general formula, and further including one or more transition metal elements selected from Co, Ni, Mn, and Fe, and having a garnet-type crystal structure in which a content X of Li and a content Y of D¹ representing one or more elements selected from Ta, Nb, and Bi are each within specific ranges.

### CROSS REFERENCE TO RELATED APPLICATIONS

The present application is a continuation of International application No. PCT/JP2023/016828, filed Apr. 28, 2023, which claims priority to Japanese Patent Application No. 2022-080944, filed May 17, 2022, the entire contents of each of which are incorporated herein by reference.

### TECHNICAL FIELD

The present disclosure relates to a solid electrolyte ceramic and a solid-state battery including the solid electrolyte ceramic.

### BACKGROUND ART

In recent years, the demand is greatly increasing for batteries as power supplies for portable electronic devices such as mobile phones and portable personal computers. As batteries for such use, sintered-type solid-state secondary batteries (so-called “solid-state batteries”) have been developed in which a solid electrolyte is used as an electrolyte and another constituent element is also a solid.

A solid-state battery includes a positive electrode layer, a negative electrode layer, and a solid electrolyte layer layered between the positive electrode layer and the negative electrode layer. In particular, the solid electrolyte layer includes a solid electrolyte ceramic, and serves for ion conduction between the positive electrode layer and the negative electrode layer. The solid electrolyte ceramic is required to have a higher ion conductivity and a lower electron conductivity. As such a solid electrolyte ceramic, a ceramic obtained by sintering a garnet-type solid electrolyte substituted with Bi has been used for an attempt from the viewpoint of higher ion conductivity (for example, Patent Document 1 and Non-Patent Document 1).
Patent Document 1: Japanese Patent Application Laid-Open No. 2015-050071
Non-Patent Document 1: Gao et al., SolidState Ionics, 181 (2010) 1415-1419

### SUMMARY OF THE DISCLOSURE

The inventors of the present disclosure have found that the following problems are caused in a solid-state battery using a conventional solid electrolyte ceramic as described above. Specifically, in a conventional solid-state battery using a garnet-type solid electrolyte ceramic containing Bi, an impurity such as a Li—Bi—O-based compound is likely to be generated at a grain boundary, and the Li—Bi—O-based compound is reduced at the time of operating (that is, at the time of charging and discharging) the solid-state battery to increase the electron conductivity. The increase in electron conductivity causes a short-circuit phenomenon of the solid-state battery and/or causes an increase in leakage current.

The inventors of the present disclosure have also found that a solid electrolyte containing a transition metal element such as Co is effective from the viewpoint of suppressing the generation of a Li—Bi—O-based compound, but has also found that the following new problem is caused. Specifically, if a solid electrolyte containing a transition metal element is used, the generation of a Li—Bi—O-based compound can be suppressed, but an impurity is newly generated that contains a transition metal such as a Li—La—Co—O-based compound, which is different from the Li—Bi—O-based compound, and the impurity also increases the electron conductivity at the time of operating the solid-state battery.

An object of the present disclosure is to provide a solid electrolyte ceramic that has excellent ion conductivity and further sufficiently suppresses an increase in electron conductivity caused by operation of a solid-state battery.

The present disclosure provides a solid electrolyte ceramic having a chemical composition represented by:

A_{α}B_{β}(D¹+D²)_{γ}O_{ω} (I)
wherein A represents one or more elements selected from Li, Ga, Al, Mg, Zn, and Sc, and A including at least Li;
B represents one or more elements selected from La, Ca, Sr, Ba, and lanthanoid elements, and B including at least La;
D¹ and D² represent one or more elements selected from transition elements capable of being six-coordinate with oxygen and elements belonging to Groups 12 to 15, D¹ represents one or more elements selected from Ta, Nb, and Bi;
5.0≤α≤8.0;
2.5≤β≤3.5;
1.5≤γ≤2.5; and
11≤ω≤13,
the solid electrolyte ceramic further including one or more transition metal elements selected from Co, Ni, Mn, and Fe,
the solid electrolyte ceramic having a garnet-type crystal structure where:
10≤Y≤70 in a range of 220<X≤245,
wherein X (mol %) represents a content of the Li and Y (mol %) represents a content of the one or more elements represented by D¹ when a content of the one or more elements represented by B is 100 mol %.

The solid electrolyte ceramic of the present disclosure has excellent ion conductivity and further sufficiently suppresses an increase in electron conductivity caused by operation of a solid-state battery.

### DESCRIPTION OF THE PREFERRED EMBODIMENTS

### [Solid Electrolyte Ceramic]

The solid electrolyte ceramic of the present disclosure includes a sintered body obtained by sintering solid electrolyte grains. The solid electrolyte ceramic of the present disclosure includes at least lithium (Li), lanthanum (La), and oxygen (O) and has a garnet-type crystal structure, and further includes one or more transition metal elements selected from the group consisting of cobalt (Co), nickel (Ni), manganese (Mn), and iron (Fe) (hereinafter, sometimes simply referred to as a “predetermined transition metal element”). Furthermore, the solid electrolyte ceramic of the present disclosure is a ceramic including a solid electrolyte having a garnet-type crystal structure, and may include another composite oxide or a single oxide as long as an effect of the present disclosure is not impaired. Furthermore, the solid electrolyte ceramic of the present disclosure may be a solid electrolyte having a so-called garnet-type crystal structure. Furthermore, the solid electrolyte ceramic of the present disclosure preferably includes bismuth (Bi) from the viewpoint of more excellent ion conductivity. At least the sintered grains included in the solid electrolyte ceramic as a main component in the present disclosure is to have a garnet-type crystal structure.

The solid electrolyte ceramic of the present disclosure preferably has a chemical composition represented by the following general formula (I) and further includes a predetermined transition metal element.

A_{α}B_{β}(D¹+D²)_{γ}O_{ω} (I)

In the general formula (I), A represents one or more elements selected from the group consisting of lithium (Li), gallium (Ga), aluminum (Al), magnesium (Mg), zinc (Zn), and scandium (Sc), and the one or more elements represented by A include at least Li.

B represents one or more elements selected from the group consisting of lanthanum (La), calcium (Ca), strontium (Sr), barium (Ba), and lanthanoid elements, and the one or more elements represented by B include at least La. Examples of the lanthanoid elements include cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

D¹ and D² represent one or more (particularly two or more) elements selected from the group consisting of transition elements capable of being six-coordinate with oxygen and typical elements belonging to Groups 12 to 15 (hereinafter, sometimes referred to as “group P”). D¹ represents one or more (particularly two or more) elements selected from the group consisting of Ta, Nb, and Bi. D² may be contained or may be not contained (in the solid electrolyte ceramic), and in a case where D² is contained, D² represents one or more elements selected from the group P other than Ta, Nb, and Bi. Examples of the transition elements capable of being six-coordinate with oxygen include scandium (Sc), zirconium (Zr), titanium (Ti), tantalum (Ta), niobium (Nb), hafnium (Hf), molybdenum (Mo), tungsten (W), and tellurium (Te). Examples of the typical elements belonging to Groups 12 to 15 include indium (In), germanium (Ge), tin (Sn), lead (Pb), antimony (Sb), and bismuth (Bi). The one or more elements represented by D¹ preferably include at least Bi, and more preferably include at least Bi and Ta, from the viewpoints of more excellent ion conductivity and more sufficient suppression of an increase in electron conductivity at the time of operation. D² may be not contained or may be contained from the viewpoints of more excellent ion conductivity and more sufficient suppression of an increase in electron conductivity at the time of operation, and in a case where D² is contained, the one or more elements represented by D² include Zr. From the viewpoints of more excellent ion conductivity and more sufficient suppression of an increase in electron conductivity at the time of operation, in a more preferred aspect, in a case where the one or more elements represented by D¹ include at least Bi and Ta, Zr may be included or may be not included in the one or more elements represented by D².

In the general formula (I), α, β, γ, and ω satisfy 5.0≤α≤8.0, 2.5≤β≤3.5, 1.5≤γ≤2.5, and 11≤ω≤13, respectively.

α preferably satisfies 6.0≤α≤8.0, more preferably 6.5<≤α≤7.5, and still more preferably 6.6≤α≤7.4, from the viewpoints of more excellent ion conductivity and more sufficient suppression of an increase in electron conductivity at the time of operation. In a case where the one or more elements represented by A include a plurality of elements, the sum of values corresponding to a for the plurality of elements is to satisfy the above range.

β preferably satisfies 2.6≤β≤3.4, more preferably 2.7≤β≤3.3, and still more preferably 2.8≤β≤3.2, from the viewpoints of more excellent ion conductivity and more sufficient suppression of an increase in electron conductivity at the time of operation. In a case where the one or more elements represented by B include a plurality of elements, the sum of values corresponding to β for the plurality of elements is to satisfy the above range.

γ preferably satisfies 1.6≤γ≤2.4, more preferably 1.7≤γ≤2.3, and still more preferably 1.8≤γ≤2.2, from the viewpoints of more excellent ion conductivity and more sufficient suppression of an increase in electron conductivity at the time of operation. The sum of values corresponding to γ for the elements of D¹ and D² is to satisfy the above range. In a case where the one or more elements represented by each of D¹ and D² include a plurality of elements, the sum of values corresponding to γ for the plurality of elements is to satisfy the above range.

ω preferably satisfies 11≤ω≤12.5, more preferably 11.5≤ω≤12.5, and still more preferably 11.8≤ω≤12.2, from the viewpoints of more excellent ion conductivity and more sufficient suppression of an increase in electron conductivity at the time of operation.

If a garnet-type solid electrolyte containing the one or more elements represented by D¹ (particularly Bi) contains a predetermined transition metal element (Co, Ni, Mn, Fe, or the like), generation of a Li—Bi—O-based compound is suppressed, but a new impurity Li—La—Co—O-based compound having electron conductivity is generated. Meanwhile, in the solid electrolyte ceramic of the present disclosure, Li and the one or more elements represented by D¹ (pentavalent elements including Nb, particularly Ta) are contained in a relatively large amount, and therefore generation of a Li—La—Co—O-based compound can also be suppressed when the predetermined transition metal element is contained in a relatively large amount. As a result, an increase in electron conductivity can be more sufficiently suppressed while excellent ion conductivity is maintained. Details of the mechanism of obtaining such an effect are unknown, but can be assumed as follows. In a system where Li and the one or more elements represented by D¹ (pentavalent elements including Nb, particularly Ta) are contained in a relatively large amount, the predetermined transition metal element more sufficiently exhibits a catalytic effect (effect of promoting oxidation of the one or more elements represented by D¹ (pentavalent elements including Nb, particularly Bi)). As a result, solid solution of the one or more elements represented by D¹ (particularly Bi) in LLZ is promoted, and thus it is considered that generation of a Li—Bi—O-based compound is suppressed and generation of a Li—La—Co—O-based compound is more sufficiently suppressed.

The predetermined transition metal element preferably includes one or more elements selected from the group consisting of Co, Ni, and Mn, more preferably includes one or more elements selected from the group consisting of Co and Mn, and still more preferably includes Co, from the viewpoints of more excellent ion conductivity and more sufficient suppression of an increase in electron conductivity at the time of operation.

In the present disclosure, the contents of Li and the one or more elements represented by D¹ (particularly Ta) in the solid electrolyte ceramic are specifically as follows. That is, in the general formula (I) representing the chemical composition of the solid electrolyte ceramic of the present disclosure, when the content of the one or more elements represented by B is 100 mol %, the solid electrolyte ceramic of the present disclosure satisfies both the following relational expressions (1) and (2) wherein X (mol %) represents the content of Li and Y (mol %) represents the content of the one or more elements represented by D¹ (particularly Ta).

(1) 220<X≤245 (preferably 221≤X≤244, and more preferably 222≤X≤243 from the viewpoints of more excellent ion conductivity and more sufficient suppression of an increase in electron conductivity at the time of operation);

(2) 10≤Y≤70 (preferably 10≤Y≤50, and more preferably 10≤Y≤30 from the viewpoints of more excellent ion conductivity and more sufficient suppression of an increase in electron conductivity at the time of operation).

In the relational expression (1), if the content X of Li is too large, the sintering property deteriorates, and in the case of using the solid electrolyte ceramic as a solid electrolyte of a solid-state battery, firing is difficult. If the content X of Li is too small, a different phase (such as a Li—La—Co—O-based compound as an impurity) appears, resulting in an increase in the electron conductivity.

In the relational expression (2), if the content Y of the one or more elements represented by D¹ (particularly Ta) is too small, the garnet-type crystal structure becomes not a cubic crystal but a tetragonal crystal structure, resulting in significant deterioration of the ion conductivity. If the content Y of the one or more elements represented by D¹ (particularly Ta) is too large, a different phase (such as an impurity or tantalum oxide) appears, resulting in significant deterioration of the ion conductivity.

The content X of Li and the content Y of the one or more elements represented by D¹ (particularly Ta) are expressed as a proportion (mol %) when the content of the one or more elements represented by B is 100 mol %, but can also be expressed as a proportion (mol %) with respect to the number of eight-coordination sites of the garnet-type crystal structure of 100 mol %. For example, in the case of the chemical composition of the general formula (II) described below, the proportion is a value that can be expressed as a proportion (mol %) with respect to the total number of La and B¹ of 100 mol %. In another specific example, the eight-coordination site of the garnet-type crystal structure refers to, for example, a site occupied by La in Li₅La₃Nb₂O₁₂ (ICDD Card No. 00-045-0109) having a garnet-type crystal structure.

The content of Li and the content of the one or more elements represented by D¹ (particularly Ta) can be measured by performing inductively coupled plasma (ICP) emission spectrometry (ICP analysis) of the solid electrolyte ceramic to obtain the average chemical composition of the material. Specifically, after determining the average chemical composition based on the ICP analysis, the content of Li and the content of the one or more elements represented by D¹ (particularly Ta) can be determined, from the average chemical composition, as proportions with respect to the content of the one or more elements represented by B in the general formula (I) of 100 mol %. For example, the contents can be determined as proportions with respect to the number of eight-coordination sites of the garnet-type crystal structure (for example, the total number of La and B¹ in the general formula (II) described below) of 100 mol %. Note that the measurement and the calculation may be performed with an X-ray photoelectron spectroscopy (XPS).

The content of the predetermined transition metal element is usually 0.01 mol % to 10 mol % when the content of the one or more elements represented by B is 100 mol %, and is preferably 0.01 mol % to 8 mol %, more preferably 0.01 mol % to 5 mol %, still more preferably 0.01 mol % to 3 mol %, and particularly preferably 0.01 mol % to 2 mol % from the viewpoints of more excellent ion conductivity and more sufficient suppression of an increase in electron conductivity at the time of operation. In a case where two or more kinds of transition metal elements are contained as the predetermined transition metal element, the total content thereof is to be within the above range.

The content of bismuth (Bi) is usually 40 mol % or less when the content of the one or more elements represented by B is 100 mol %, and is preferably 0.1 mol % to 30 mol %, more preferably 0.5 mol % to 20 mol %, still more preferably 0.5 mol % to 15 mol %, and particularly preferably 1 mol % to 10 mol % from the viewpoints of more excellent ion conductivity and more sufficient suppression of an increase in electron conductivity at the time of operation.

The content of tantalum (Ta) is usually 80 mol % or less when the content of the one or more elements represented by B is 100 mol %, and is preferably 1 mol % to 80 mol %, more preferably 5 mol % to 75 mol %, still more preferably 10 mol % to 70 mol %, and particularly preferably 12 mol % to 68 mol % from the viewpoints of more excellent ion conductivity and more sufficient suppression of an increase in electron conductivity at the time of operation.

The content of zirconium (Zr) is usually 70 mol % or less (particularly 0 mol % to 70 mol %) when the content of the one or more elements represented by B is 100 mol %, and is preferably 0 mol % to 60 mol %, more preferably 0 mol % to 55 mol %, and still more preferably 0 mol % to 50 mol % from the viewpoints of more excellent ion conductivity and more sufficient suppression of an increase in electron conductivity at the time of operation. The content of Zr of 0 mol % means that the solid electrolyte ceramic (particularly, D¹ of the general formula (I) or D¹ of the general formula (II)) does not contain Zr.

The contents of the predetermined transition metal element, Bi, Ta, and Zr can be measured, similarly to the content X of Li and the content Y of the one or more elements represented by D¹ (particularly Ta), by performing inductively coupled plasma (ICP) emission spectrometry (ICP analysis) of the solid electrolyte ceramic to obtain the average chemical composition of the material. Specifically, after determining the average chemical composition based on the ICP analysis, the contents of the predetermined transition metal element, Bi, Ta, and Zr can be determined, from the average chemical composition, as proportions with respect to the content of the one or more elements represented by B in the general formula (I) (for example, the total number of La and B¹ in the general formula (II) described below) of 100 mol %. Note that the measurement and the calculation may be performed with an X-ray photoelectron spectroscopy (XPS).

The existence form (or contained form) of the predetermined transition metal element in the solid electrolyte ceramic of the present disclosure is not particularly limited, and the predetermined transition metal element may exist, for example, in a crystal lattice or in a site other than a crystal lattice. Specifically, the predetermined transition metal element may exist in a bulk, at a grain boundary, or both in a bulk and at a grain boundary in the solid electrolyte ceramic. The fact that the predetermined transition metal element exists in a bulk means that the predetermined transition metal element exists in a metal site (lattice site) included in a garnet-type crystal structure in the solid electrolyte ceramic of the present disclosure. The metal site may be any metal site, and may be, for example, a Li site, a La site, a Bi site, or two or more of these sites. The fact that the predetermined transition metal element exists at a grain boundary means that the solid electrolyte ceramic of the present disclosure includes a plurality of sintered grains and the predetermined transition metal element may exist at an interface between two or more of the sintered grains.

In the present disclosure, the predetermined transition metal element may exist as a composite oxide including the predetermined transition metal element and one or more metal elements selected from the group consisting of other metal elements that can be included in the garnet-type solid electrolyte of the present disclosure and/or as a single oxide. Such an oxide of the predetermined transition metal element may exist at an interface between crystal grains of the ceramic having a garnet-type crystal structure as a main component in the present disclosure.

In the solid electrolyte ceramic of the present disclosure, the one or more elements represented by A (for example, Li) may usually exist in a bulk, and specifically, for example, may exist in a Li site as a metal site (lattice site) included in a garnet-type crystal structure. At this time, a part of the one or more elements represented by A may exist, at a grain boundary, as a composite oxide including the one or more elements represented by A and one or more metal elements selected from the group consisting of other metal elements that can be included in the garnet-type solid electrolyte of the present disclosure and/or as a single oxide.

In the solid electrolyte ceramic of the present disclosure, the one or more elements represented by B (for example, La) may usually exist in a bulk, and specifically, for example, may exist in a La site as a metal site (lattice site) included in a garnet-type crystal structure. At this time, a part of the one or more elements represented by B may exist, at a grain boundary, as a composite oxide including the one or more elements represented by B and one or more metal elements selected from the group consisting of other metal elements that can be included in the garnet-type solid electrolyte of the present disclosure and/or as a single oxide.

In the solid electrolyte ceramic of the present disclosure, the one or more elements represented by D¹ (for example, Bi, Ta, and Zr) may usually exist in a bulk, and specifically, for example, may exist in a six-coordination site as a metal site (lattice site) included in a garnet-type crystal structure. At this time, a part of the one or more elements represented by D¹ may exist, at a grain boundary, as a composite oxide including the one or more elements represented by D¹ and one or more metal elements selected from the group consisting of other metal elements that can be included in the garnet-type solid electrolyte of the present disclosure and/or as a single oxide.

In the present disclosure, the fact that the solid electrolyte ceramic has a garnet-type crystal structure means not only that the solid electrolyte ceramic has a “garnet-type crystal structure” but also that the solid electrolyte ceramic has a “pseudo-garnet-type crystal structure”. Specifically, the solid electrolyte ceramic of the present disclosure has a crystal structure that can be identified as a garnet-type or pseudo-garnet-type crystal structure by those skilled in the field of solid-state batteries in X-ray diffraction. More specifically, in X-ray diffraction, the solid electrolyte ceramic of the present disclosure may show one or more main peaks corresponding to Miller indices unique to a so-called garnet-type crystal structure diffraction pattern: ICDD Card No. 422259) at a predetermined incident angle, or the solid electrolyte ceramic as a pseudo-garnet-type crystal structure may show one or more main peaks having an incident angle (that is, peak position or diffraction angle) and an intensity ratio (that is, peak intensity ratio or diffraction intensity ratio) that are different, due to a difference in composition, from those of one or more main peaks corresponding to Miller indices unique to a so-called garnet-type crystal structure. Examples of a typical diffraction pattern of a pseudo-garnet-type crystal structure include ICDD Card No. 00-045-0109.

The solid electrolyte ceramic of the present disclosure can have a chemical composition represented by the general formula (II) as a specific embodiment. Specifically, the solid electrolyte ceramic can have the chemical composition represented by the general formula (II) as a whole. At this time, the solid electrolyte ceramic of the present disclosure further includes the predetermined transition metal element as described above while having the chemical composition represented by the general formula (II).

(LiₚA¹_{y})(La_{q}B¹_{z})(D¹_{γ-x}Biₓ)O_{12-δ} (II)

In the general formula (II), A¹ represents a metal element occupying a Li site in a garnet-type crystal structure. A¹ represents an element corresponding to A in the general formula (I), and may represent one or more elements selected from the group consisting of the elements other than Li among the same elements as the above-described examples of A. A¹ usually represents one or more elements selected from the group consisting of gallium (Ga), aluminum (Al), magnesium (Mg), zinc (Zn), and scandium (Sc). A¹ represents preferably one or more elements selected from the group consisting of gallium (Ga) and aluminum (Al), and more preferably two elements of Ga and Al from the viewpoints of more excellent ion conductivity and more sufficient suppression of an increase in electron conductivity at the time of operation.

In the general formula (II), B¹ represents a metal element occupying a La site in the garnet-type crystal structure. B¹ represents an element corresponding to β in the general formula (I), and may represent one or more elements selected from the group consisting of the elements other than La among the same elements as the above-described examples of B. B¹ usually represents one or more elements selected from the group consisting of calcium (Ca), strontium (Sr), barium (Ba), and lanthanoid elements.

In the general formula (II), D¹ represents a metal element occupying a six-coordination site in the garnet-type crystal structure (the site occupied by Zr in the garnet-type crystal structure Li₇La₃Zr₂O₁₂ (ICDD Card. No 01-078-6708)). D¹ represents an element corresponding to D in the general formula (I), and may represent one or more elements selected from the group consisting of the elements other than Bi among the same elements as the above-described examples of D¹. D¹ usually represents one or more elements selected from the group consisting of zirconium (Zr), hafnium (Hf), tantalum (Ta), niobium (Nb), molybdenum (Mo), tungsten (W), and tellurium (Te), and from the viewpoints of more excellent ion conductivity and more sufficient suppression of an increase in electron conductivity at the time of operation, one or more elements selected from the group consisting of zirconium (Zr) and tantalum (Ta) are preferably included, and at least tantalum (Ta) is more preferably included.

In the general formula (II), x satisfies 0<x≤1.00, and from the viewpoints of more excellent ion conductivity and more sufficient suppression of an increase in electron conductivity at the time of operation, preferably satisfies 0.01≤x≤0.70, more preferably 0.02≤x≤0.60, still more preferably 0.03≤x≤0.50, particularly preferably 0.03≤x≤0.40, and most preferably 0.04≤x≤0.25.

y satisfies 0≤y≤0.50, and from the viewpoints of more excellent ion conductivity and more sufficient suppression of an increase in electron conductivity at the time of operation, preferably satisfies 0≤y≤0.40, more preferably 0≤y≤0.30, still more preferably 0≤y≤0.20, and is particularly preferably 0. In a case where the one or more elements represented by Al include a plurality of elements, the sum of values corresponding to γ for the plurality of elements is to satisfy the above range.

z satisfies 0≤z≤2.00, and from the viewpoints of more excellent ion conductivity and more sufficient suppression of an increase in electron conductivity at the time of operation, preferably satisfies 0≤z≤0.35, more preferably 0≤z≤0.08, still more preferably 0≤z≤0.04, and is most preferably 0. In a case where the one or more elements represented by B¹ include a plurality of elements, the sum of values corresponding to z for the plurality of elements is to satisfy the above range.

Y satisfies 1.2≤y≤3.2, and from the viewpoints of more excellent ion conductivity and more sufficient suppression of an increase in electron conductivity at the time of operation, preferably satisfies 1.4≤y≤3.0, more preferably 1.6≤γ≤2.8, and still more preferably 1.8≤y≤2.4.

“γ−x” satisfies 1.0≤γ−x≤3.0, and from the viewpoints of more excellent ion conductivity and more sufficient suppression of an increase in electron conductivity at the time of operation, preferably satisfies 1.2≤γ−x≤2.8, more preferably 1.4≤y−x≤2.6, and still more preferably 1.6≤y−x≤2.2. In a case where the one or more elements represented by D¹ include a plurality of elements, the sum of values corresponding to “y−x” for the plurality of elements is to satisfy the above range.

In the general formula (II), p satisfies 5.0≤p≤8.0, and from the viewpoints of more excellent ion conductivity and more sufficient suppression of an increase in electron conductivity at the time of operation, p satisfies 6.0≤p≤8.0, more preferably 6.5≤p≤7.5, and still more preferably 6.6≤p≤7.4.

a is the average valence of A¹. The average valence of A¹ is, for example, a value represented by (n1×a+n2×b+n3×c)/(n1+n2+n3) in a case where the number of elements X having a valence of a+ is n1, the number of elements Y having a valence of b+ is n2, and the number of elements Z having a valence of c+ is n3 in the elements represented by A¹.

b is the average valence of B¹. The average valence of B¹ is, for example, the same value as the above-described average valence of A¹ in a case where the number of elements X having a valence of a+ is n1, the number of elements Y having a valence of b+ is n2, and the number of elements Z having a valence of c+ is n3 in the elements represented by B¹.

c is the average valence of D¹. The average valence of D¹ is, for example, the same value as the above-described average valence of A¹ in a case where the number of elements X having a valence of a+ is n1, the number of elements Y having a valence of b+ is n2, and the number of elements Z having a valence of c+ is n3 in the elements represented by D¹.

In the general formula (II), q satisfies 2.5≤q≤3.5, and from the viewpoints of more excellent ion conductivity and more sufficient suppression of an increase in electron conductivity at the time of operation, preferably satisfies 2.6≤q≤3.4, more preferably 2.7≤q≤3.3, and still more preferably 2.8≤q≤3.2.

δ represents an oxygen deficiency amount and may be 0. δ is usually to satisfy 0≤δ<1. The oxygen deficiency amount δ cannot be quantitatively analyzed using the latest device, and therefore may be regarded as 0.

The molar ratio of each element in the chemical composition of the solid electrolyte ceramic of the present disclosure does not necessarily coincide with, for example, the molar ratio of each element in the general formula (II), and tends to deviate from this molar ratio according to the analysis method, but an effect of the present disclosure is exhibited as long as the compositional deviation does not change the characteristics.

It goes without saying that in a case where the solid electrolyte ceramic of the present disclosure has a chemical composition represented by the general formula (II), the content X of Li and the content Y of the one or more elements represented by D¹ (particularly Ta) satisfy the relational expressions (1) and (2), respectively, as in a case where the solid electrolyte ceramic has a chemical composition represented by the general formula (I). In this case, the content of each of the predetermined transition metal element, Bi, Ta, and Zr may be within the above range, and is preferably within the above range. The phrase “with respect to the content of the one or more elements represented by B of 100 mol %” showing a reference in these descriptions of the content may be read as “with respect to the total number (that is, the total content) of La and B¹ of 100 mol %”.

In the present disclosure, the chemical composition of the solid electrolyte ceramic may be the composition of the whole ceramic material determined using an inductively coupled plasma method (ICP). The chemical composition may be measured and calculated using XPS analysis, or may be determined using energy dispersive X-ray spectroscopy (TEM-EDX) and/or wavelength dispersive X-ray spectroscopy (WDX). The chemical composition may be obtained by performing quantitative analysis (composition analysis) at arbitrary 100 points of each of arbitrary 100 sintered grains and calculating the average of the resulting values.

The content [for example, the molar ratio with respect to the content of the one or more elements represented by B in the general formula (I) (or the total number of La and B¹ in the general formula (II)) of 100 mol %] of the predetermined transition metal element (that is, Co, Ni, Mn, and Fe) in the solid electrolyte ceramic of the present disclosure may be calculated with the following method. In the present disclosure, the chemical composition of the solid electrolyte ceramic can be determined by ICP analysis (inductively coupled plasma method), LA-ICP-MS (laser ablation ICP mass spectrometry) analysis, or the like. The chemical composition may be measured and calculated using XPS analysis, energy dispersive X-ray spectroscopy (TEM-EDX), or wavelength dispersive X-ray spectroscopy (WDX). The chemical composition may be obtained by performing quantitative analysis (composition analysis) at arbitrary 100 points of each of arbitrary 100 sintered grains and calculating the average of the resulting values.

For example, the analysis by EDX or WDX measures a section of a solid-state battery. The section of a solid-state battery is a section parallel to the direction of stacking a positive electrode layer, a solid electrolyte layer, and a negative electrode layer. The section of a solid-state battery can be exposed by polishing after embedding the solid-state battery in a resin. The method of polishing the section is not particularly limited, and the solid electrolyte layer can be exposed by cutting with a dicer or the like followed by polishing using polishing paper, chemical mechanical polishing, ion milling, or the like. The exposed section (solid electrolyte layer) is quantitatively analyzed by EDX or WDX (wavelength dispersive X-ray fluorescence analyzer), and thus the molar ratio of each element (for example, the molar ratios of Co, Ni, Mn, and Fe with respect to B) can be calculated.

For example, in TEM-EELS measurement, an electrode layer or a solid electrolyte layer of a solid-state battery is peeled using a focused ion beam (FIB) or the like, and then the solid electrolyte site is subjected to transmission microscope-electron energy-loss spectroscopy (TEM-EELS) measurement. Thus, each element (for example, an element included in the one or more elements represented by B in the general formula (I), Co, Ni, Mn, or Fe) can be detected, and the molar ratio of each element with respect to the content of B can be calculated.

Specific examples of the chemical composition that represents the solid electrolyte ceramic of the present disclosure include the following chemical compositions. In each chemical composition shown below, the transition metal element after the hyphen (-) may exist in a bulk and/or at a grain boundary as described above.
Li_{6.7}La₃Zr_{1.4}Ta_{0.42}Bi_{0.2}O₁₂—Co_{0.05}
Li_{6.7}La₃Zr_{0.8}Ta₁Bi_{0.2}O₁₂—Co_{0.05}
Li_{6.7}La₃Ta_{1.95}Bi_{0.05}O₁₂—Co_{0.05}
Li_{6.9}La₃Zr_{1.4}Ta_{0.42}Bi_{0.2}O₁₂—Co_{0.05}
Li_{6.9}La₃Zr_{0.8}Ta₁Bi_{0.2}O₁₂—Co_{0.05}
Li_{6.9}La₃Ta_{1.95}Bi_{0.05}O₁₂—Co_{0.05}
Li_{7.3}La₃Zr_{1.4}Ta_{0.42}Bi_{0.2}O₁₂—Co_{0.05}
Li_{7.3}La₃Zr_{0.8}Ta₁Bi_{0.2}O₁₂—Co_{0.05}
Li_{7.3}La₃Ta_{1.95}Bi_{0.05}O₁₂—Co_{0.05}
Li_{6.9}La₃Zr_{1.4}Ta_{0.42}Bi_{0.2}O₁₂—Co_{0.005}
Li_{6.9}La₃Zr_{1.4} Ta_{0.42}Bi_{0.2}O₁₂—Co_{0.001}
Li_{6.9}La₃Zr_{1.4}Ta_{0.42}Bi_{0.2}O₁₂—Mn_{0.005}
Li_{6.9}La₃Zr_{1.4} Ta_{0.42}Bi_{0.2}O₁₂—Mn_{0.001}
Li_{6.9}La₃Zr_{1.4}Ta_{0.42}Bi_{0.2}O₁₂—Ni_{0.005}
Li_{6.9}La₃Zr_{1.4}Ta_{0.42}Bi_{0.2}O₁₂—Ni_{0.001}

In the above-described specific examples of the chemical composition, for example, the chemical compositions including Co as a transition element may be a chemical composition including Ni, Mn, or Fe instead of Co. For example, the chemical compositions including Mn as a transition element may be a chemical composition including Co, Ni, or Fe instead of Mn. For example, the chemical compositions including Ni as a transition element may be a chemical composition including Co, Mn, or Fe instead of Ni.

### [Method of Producing Solid Electrolyte Ceramic]

The solid electrolyte ceramic of the present disclosure can be obtained by mixing a compound including predetermined metal elements (that is, starting material) with water, drying the mixture, and then heat-treating the dried mixture. The compound including predetermined metal elements is usually a mixture of compounds including one metal element selected from the group consisting of lithium (Li), lanthanum (La), bismuth (Bi), and the predetermined transition metal element. Examples of the compound including predetermined metal elements (that is, starting material) include lithium hydroxide monohydrate LiOH·H₂O, lanthanum hydroxide La(OH)₃, zirconium oxide ZrO₂, tantalum oxide Ta₂O₅, bismuth oxide Bi₂O₃, cobalt oxide Co₃O₄, basic nickel carbonate hydrate NiCo₃·2Ni(OH)₂·4H₂O, manganese carbonate MnCo₃, iron oxide Fe₂O₃, lithium nitrate LiNO₃, lanthanum nitrate hexahydrate La(NO₃)₃·6H₂O, and bismuth nitrate pentahydrate Bi(NO₃)₃·5H₂O. The mixing ratio of the compound including predetermined metal elements is to be a ratio such that the solid electrolyte ceramic of the present disclosure has a predetermined chemical composition after the heat treatment. The heat treatment temperature is usually 500° C. or higher and 1200° C. or lower, and preferably 600° C. or higher and 1000° C. or lower. The heat treatment time is usually 10 minutes or longer and 1440 minutes or shorter, and particularly is 60 minutes or longer and 600 minutes or shorter.

The solid electrolyte ceramic of the present disclosure may include a sintering aid. As the sintering aid, any sintering aid known in the field of solid-state batteries can be used. The composition of such a sintering aid includes at least lithium (Li), boron (B), and oxygen (O), and the molar ratio of Li to B (Li/B) is preferably 2.0 or more. Specific examples of such a sintering aid include Li₃BO₃, (Li_{2.7}Al_{0.3})BO₃, Li_{2.8} (B_{0.8}C_{0.2})O₃, and LiBO₂.

The content of the sintering aid is usually preferably 0% to 10%, and particularly 0% to 5% with respect to the volume ratio of the garnet-type solid electrolyte.

### [Solid-State Battery]

The term “solid-state battery” in the present description refers, in a broad sense, to a battery in which constituent elements (in particular, an electrolyte layer) are solid, and in a narrow sense, to an “all-solid-state battery” in which constituent elements (in particular, all constituent elements) are solid. The “solid-state battery” in the present description encompasses a so-called “secondary battery”, which can be repeatedly charged and discharged, and a “primary battery”, which can only be discharged. The “solid-state battery” is preferably a “secondary battery”. The “secondary battery” is not excessively limited by its name, and can encompass, for example, an electrochemical device such as a “power storage device”.

The solid-state battery of the present disclosure includes a positive electrode layer, a negative electrode layer, and a solid electrolyte layer, and usually has a stacked structure including the positive electrode layer and the negative electrode layer stacked with the solid electrolyte layer interposed therebetween. Two or more positive electrode layers and two or more negative electrode layers may be stacked as long as a solid electrolyte layer is provided between a positive electrode layer and a negative electrode layer. The solid electrolyte layer is in contact with and sandwiched between the positive electrode layer and the negative electrode layer. The positive electrode layer and the solid electrolyte layer may be integrally sintered with each other to form integrally sintered bodies, and/or the negative electrode layer and the solid electrolyte layer may be integrally sintered with each other to form integrally sintered bodies. Being integrally sintered with each other to form integrally sintered bodies means that two or more members (in particular, layers) adjacent to or in contact with each other are joined by sintering. Here, the two or more members (in particular, layers) are sintered bodies and may be integrally sintered.

The above-described solid electrolyte ceramic of the present disclosure is useful as a solid electrolyte of a solid-state battery. Accordingly, the solid-state battery of the present disclosure includes the above-described solid electrolyte ceramic of the present disclosure as a solid electrolyte. Specifically, the solid electrolyte ceramic of the present disclosure is included as a solid electrolyte in at least one layer selected from the group consisting of the positive electrode layer, the negative electrode layer, and the solid electrolyte layer. The solid electrolyte ceramic of the present disclosure is preferably included in at least the solid electrolyte layer from the viewpoints of more excellent ion conductivity and more sufficient suppression of an increase in electron conductivity at the time of operation in the solid electrolyte layer.

### (Positive Electrode Layer)

In the solid-state battery of the present disclosure, the positive electrode layer is not particularly limited. For example, the positive electrode layer includes a positive electrode active material, and may further include the solid electrolyte ceramic of the present disclosure. If the positive electrode layer includes the solid electrolyte ceramic of the present disclosure, a short circuit of the solid-state battery can be suppressed. The positive electrode layer may have a form of a sintered body including positive electrode active material particles and, if desired, the solid electrolyte ceramic of the present disclosure. The positive electrode layer may be a layer capable of occluding and releasing ions (in particular, lithium ions).

The positive electrode active material is not particularly limited, and a positive electrode active material known in the field of solid-state batteries can be used. Examples of the positive electrode active material include lithium-containing phosphate compound particles having a NASICON-type structure, lithium-containing phosphate compound particles having an olivine-type structure, lithium-containing layered oxide particles, and lithium-containing oxide particles having a spinel-type structure. Specific examples of a preferably used lithium-containing phosphate compound having a NASICON-type structure include Li₃V₂(PO₄)₃. Specific examples of a preferably used lithium-containing phosphate compound having an olivine-type structure include Li₃Fe₂(PO₄)₃ and LiMnPO₄. Specific examples of a preferably used lithium-containing layered oxide particles include LiCoO₂ and LiCo_{1/3}Ni_{1/3}Mn_{1/3}O₂. Specific examples of a preferably used lithium-containing oxide having a spinel-type structure include LiMn₂O₄, LiNi_{0.5}Mn_{1.5}O₄, and Li₄Ti₅O₁₂. From the viewpoint of reactivity at the time of co-sintering with the LISICON-type solid electrolyte used in the present disclosure, lithium-containing layered oxides such as LiCoO₂ and LiCo_{1/3}Ni_{1/3}Mn_{1/3}O₂ are more preferably used as the positive electrode active material. Only one kind of these positive electrode active material particles may be used, or a plurality of kinds thereof may be mixed and used.

The fact that the positive electrode active material has a NASICON-type structure in the positive electrode layer means that the positive electrode active material (in particular, particles of the positive electrode active material) has a NASICON-type crystal structure, and in a broad sense, refers to the fact that the positive electrode active material has a crystal structure that can be identified as a NASICON-type crystal structure by those skilled in the field of solid-state batteries. In a narrow sense, the fact that the positive electrode active material has a NASICON-type structure in the positive electrode layer means that in X-ray diffraction, the positive electrode active material (in particular, particles of the positive electrode active material) shows one or more main peaks corresponding to Miller indices unique to a so-called NASICON-type crystal structure at a predetermined incident angle. Examples of a preferably used positive electrode active material having a NASICON-type structure include the compounds described above as examples.

The fact that the positive electrode active material has an olivine-type structure in the positive electrode layer means that the positive electrode active material (in particular, particles of the positive electrode active material) has an olivine-type crystal structure, and in a broad sense, refers to the fact that the positive electrode active material has a crystal structure that can be identified as an olivine-type crystal structure by those skilled in the field of solid-state batteries. In a narrow sense, the fact that the positive electrode active material has an olivine-type structure in the positive electrode layer means that in X-ray diffraction, the positive electrode active material (in particular, particles of the positive electrode active material) shows one or more main peaks corresponding to Miller indices unique to a so-called olivine-type crystal structure at a predetermined incident angle. Examples of a preferably used positive electrode active material having an olivine-type structure include the compounds described above as examples.

The fact that the positive electrode active material has a spinel-type structure in the positive electrode layer means that the positive electrode active material (in particular, particles of the positive electrode active material) has a spinel-type crystal structure, and in a broad sense, refers to the fact that the positive electrode active material has a crystal structure that can be identified as a spinel-type crystal structure by those skilled in the field of solid-state batteries. In a narrow sense, the fact that the positive electrode active material has a spinel-type structure in the positive electrode layer means that in X-ray diffraction, the positive electrode active material (in particular, particles of the positive electrode active material) shows one or more main peaks corresponding to Miller indices unique to a so-called spinel-type crystal structure at a predetermined incident angle. Examples of a preferably used positive electrode active material having a spinel-type structure include the compounds described above as examples.

The chemical composition of the positive electrode active material may be an average chemical composition. The average chemical composition of the positive electrode active material means the average of the chemical composition of the positive electrode active material in the thickness direction of the positive electrode layer. The average chemical composition of the positive electrode active material can be analyzed and measured by breaking the solid-state battery and performing composition analysis by EDX using energy dispersive X-ray spectroscopy (SEM-EDX) in a field of view into which the whole positive electrode layer fits in the thickness direction.

The positive electrode active material can be produced, for example, with the following method, or can be obtained as a commercially available product. In the case of producing a positive electrode active material, first, a raw material compound containing a predetermined metal atom is weighed out so as to have a predetermined chemical composition, and water is added and mixed to obtain a slurry. Next, the slurry is dried, calcined at 700° C. or higher and 1000° C. or lower for 1 hour or longer and 30 hours or shorter, and pulverized, and thus a positive electrode active material can be obtained.

The chemical composition and the crystal structure of the positive electrode active material in the positive electrode layer may be usually changed by element diffusion at the time of sintering. The positive electrode active material may have the chemical composition and the crystal structure described above in the solid-state battery after being sintered together with the negative electrode layer and the solid electrolyte layer.

The average particle size of the positive electrode active material is not particularly limited, and may be, for example, 0.01 μm to 10 μm, and particularly 0.05 μm to 4 μm.

The average particle size (arithmetic average) of the positive electrode active material can be determined by, for example, randomly selecting 10 to 100 particles from a SEM image, and simply averaging the particle sizes thereof.

The particle size is the diameter of a spherical particle when the particle is assumed to be a perfect sphere. Such a particle size can be determined by, for example, cutting out a section of the solid-state battery, photographing a sectional SEM image using a SEM, then calculating the sectional area S of the particle using image analysis software (for example, “Azo-kun” (manufactured by Asahi Kasei Engineering Corporation)), and then determining the particle diameter R by the following formula:

$$R = 2 \times {( S / π )}^{1 / 2}$$

The average particle size of the positive electrode active material in the positive electrode layer can be automatically measured by specifying the positive electrode active material based on the composition at the time of measuring the average chemical composition described above.

The average particle size of the positive electrode active material in the positive electrode layer may usually change due to sintering in the process of producing the solid-state battery. In the solid-state battery after being sintered together with the negative electrode layer and the solid electrolyte layer, the positive electrode active material may have the above-described average particle size.

The volume percentage of the positive electrode active material in the positive electrode layer is not particularly limited, and may be, for example, 30% to 90%, and particularly 40% to 70%.

The positive electrode layer may include the solid electrolyte ceramic of the present disclosure as a solid electrolyte, and/or may include a solid electrolyte other than the solid electrolyte ceramic of the present disclosure.

The positive electrode layer may further include a sintering aid and/or, for example, a conductive material.

In a case where the positive electrode layer includes the solid electrolyte ceramic of the present disclosure, the volume percentage of the solid electrolyte ceramic of the present disclosure may be usually 20% to 60%, and particularly 30% to 45%.

As the sintering aid in the positive electrode layer, the same compound as the sintering aid that may be included in the solid electrolyte ceramic can be used.

The volume percentage of the sintering aid in the positive electrode layer is not particularly limited, and may be, for example, 0.1% to 20%, and particularly 1% to 10%.

As the conductive material in the positive electrode layer, a conductive material known in the field of solid-state batteries can be used. Examples of a preferably used conductive material include metal materials such as silver (Ag), gold (Au), palladium (Pd), platinum (Pt), copper (Cu), tin (Sn), and nickel (Ni); and carbon materials such as acetylene black, Ketjen black, Super P (registered trademark), and carbon nanotubes such as VGCF (registered trademark). The shape of the carbon material is not particularly limited, and a material to be used may have any shape such as a spherical shape, a plate shape, or a fibrous shape.

The volume percentage of the conductive material in the positive electrode layer is not particularly limited, and may be, for example, 10% to 50%, and particularly 20% to 40%.

The thickness of the positive electrode layer is usually 0.1 to 30 μm, and for example, preferably 1 to 20 μm. As the thickness of the positive electrode layer, the average of thicknesses measured at any 10 points in a SEM image is used.

The porosity of the positive electrode layer is not particularly limited, and may be, for example, 20% or less, usually 15% or less, and particularly 10% or less.

As the porosity of the positive electrode layer, a value measured from a SEM image after FIB section processing is used.

The positive electrode layer is a layer that may be referred to as a “positive electrode active material layer”. The positive electrode layer may have a so-called positive electrode current collector or positive electrode current collecting layer.

### (Negative Electrode Layer)

In the solid-state battery of the present disclosure, the negative electrode layer is not particularly limited. For example, the negative electrode layer includes a negative electrode active material, and may further include the solid electrolyte ceramic of the present disclosure. If the negative electrode layer includes the solid electrolyte ceramic of the present disclosure, a short circuit of the solid-state battery can be suppressed. The negative electrode layer may have a form of a sintered body including negative electrode active material particles and, if desired, the solid electrolyte ceramic of the present disclosure. The negative electrode layer may be a layer capable of occluding and releasing ions (in particular, lithium ions).

The negative electrode active material is not particularly limited, and a negative electrode active material known in the field of solid-state batteries can be used. Examples of the negative electrode active material include carbon materials such as graphite, graphite-lithium compounds, a lithium metal, lithium alloy particles, phosphate compounds having a NASICON-type structure, Li-containing oxides having a spinel-type structure, and oxides having a β_{II}-Li₃VO₄-type structure or a γ_{II}-Li₃VO₄-type structure. As the negative electrode active material, a lithium metal or a Li-containing oxide having a β_{II}-Li₃VO₄-type structure or a γ_{II}-Li₃VO₄-type structure is preferably used.

The fact that the oxide has a β_{II}-Li₃VO₄-type structure in the negative electrode layer means that the oxide (in particular, particles of the oxide) has a β_{II}-Li₃VO₄-type crystal structure, and in a broad sense, refers to the fact that the oxide has a crystal structure that can be identified as a β_{II}-Li₃VO₄-type crystal structure by those skilled in the field of solid-state batteries. In a narrow sense, the fact that the oxide has a β_{II}-Li₃VO₄-type structure in the negative electrode layer means that in X-ray diffraction, the oxide (in particular, particles of the oxide) shows one or more main peaks corresponding to Miller indices unique to a so-called β_{II}-Li₃VO₄-type crystal structure at a predetermined incident angle. Examples of a preferably used Li-containing oxide having a β_{II}-Li₃VO₄-type structure include Li₃VO₄.

The fact that the oxide has a γ_{II}-Li₃VO₄-type structure in the negative electrode layer means that the oxide (in particular, particles of the oxide) has a γ_{II}-Li₃VO₄-type crystal structure, and in a broad sense, refers to the fact that the oxide has a crystal structure that can be identified as a γ_{II}-Li₃VO₄-type crystal structure by those skilled in the field of solid-state batteries. In a narrow sense, the fact that the oxide has a γ_{II}-Li₃VO₄-type structure in the negative electrode layer means that in X-ray diffraction, the oxide (in particular, particles of the oxide) shows one or more main peaks corresponding to Miller indices unique to a so-called γ_{II}-Li₃VO₄-type crystal structure at a predetermined incident angle (x-axis). Examples of a preferably used Li-containing oxide having a γ_{II}-Li₃VO₄-type structure include Li_{3.2}V_{0.8}Si_{0.2}O₄.

The chemical composition of the negative electrode active material may be an average chemical composition. The average chemical composition of the negative electrode active material means the average of the chemical composition of the negative electrode active material in the thickness direction of the negative electrode layer. The average chemical composition of the negative electrode active material can be analyzed and measured by breaking the solid-state battery and performing composition analysis by EDX using energy dispersive X-ray spectroscopy (SEM-EDX) in a field of view into which the whole negative electrode layer fits in the thickness direction.

The negative electrode active material can be produced, for example, with the same method as the positive electrode active material, or can be obtained as a commercially available product.

The chemical composition and the crystal structure of the negative electrode active material in the negative electrode layer may be usually changed by element diffusion at the time of sintering in a process of producing a solid-state battery. The negative electrode active material may have the average chemical composition and the crystal structure described above in the solid-state battery after being sintered together with the positive electrode layer and the solid electrolyte layer.

The volume percentage of the negative electrode active material in the negative electrode layer is not particularly limited, and may be, for example, 50% or more (particularly 50% to 99%), usually 70% to 95%, and particularly 80% to 90%.

The negative electrode layer may include the solid electrolyte ceramic of the present disclosure as a solid electrolyte, and/or may include a solid electrolyte other than the solid electrolyte ceramic of the present disclosure.

The negative electrode layer may further include a sintering aid and/or, for example, a conductive material.

In a case where the negative electrode layer includes the solid electrolyte ceramic of the present disclosure, the volume percentage of the solid electrolyte ceramic of the present disclosure may be usually 20% to 60%, and particularly 30% to 45%.

As the sintering aid in the negative electrode layer, the same compound as the sintering aid in the positive electrode layer can be used.

As the conductive material in the negative electrode layer, the same compound as the conductive material in the positive electrode layer can be used.

The thickness of the negative electrode layer is usually 0.1 to 30 μm, and preferably 1 to 20 μm. As the thickness of the negative electrode layer, the average of thicknesses measured at any 10 points in a SEM image is used.

The porosity of the negative electrode layer is not particularly limited, and may be, for example, 20% or less, usually 15% or less, and particularly 10% or less.

As the porosity of the negative electrode layer, a value is used that is measured with the same method as the porosity of the positive electrode layer.

The negative electrode layer is a layer that may be referred to as a “negative electrode active material layer”. The negative electrode layer may have a so-called negative electrode current collector or negative electrode current collecting layer.

### (Solid Electrolyte Layer)

In the solid-state battery of the present disclosure, the solid electrolyte layer preferably includes the above-described solid electrolyte ceramic of the present disclosure from the viewpoints of more excellent ion conductivity and more sufficient suppression of an increase in electron conductivity at the time of operation.

The volume percentage of the solid electrolyte ceramic of the present disclosure in the solid electrolyte layer is not particularly limited, and is preferably 10% to 100%, more preferably 20% to 100%, and still more preferably 30% to 100% from the viewpoints of more excellent ion conductivity and more sufficient suppression of an increase in electron conductivity at the time of operation.

In a case where the solid electrolyte layer includes the solid electrolyte ceramic of the present disclosure, the solid electrolyte ceramic of the present disclosure having the above-described chemical composition is to exist at least at the central part (particularly, 5 points or more, preferably 8 points or more, and more preferably 10 points in the arbitrary 10 points) in the thickness direction of the solid electrolyte layer. This is because the solid electrolyte layer is sandwiched between the positive electrode layer and the negative electrode layer and thus sintering in a process of producing a solid-state battery may cause element diffusion from the positive electrode layer and the negative electrode layer to the solid electrolyte layer and/or element diffusion from the solid electrolyte layer to the positive electrode layer and the negative electrode layer.

The solid electrolyte layer may include one or more materials, in addition to the garnet-type solid electrolyte ceramic of the present disclosure, selected from solid electrolytes including at least Li, Zr, and 0, solid electrolytes having a γ-Li₃VO₄ structure, and oxide glass ceramic-based lithium ion conductors. Examples of the solid electrolytes including at least Li, Zr, and O include Li₂ZrO₃.

Examples of the solid electrolytes having a γ-Li₃VO₄ structure include solid electrolytes having an average chemical composition represented by the following general formula (III):

(Li_{[3-a x+(5-c)(1-y)]}Aₓ)(B_{y}D_{1-y})O₄ (III)

In the general formula (III), A represents one or more elements selected from the group consisting of Na, K, Mg, Ca, Al, Ga, Zn, Fe, Cr, and Co.

B represents one or more elements selected from the group consisting of V and P.

D represents one or more elements selected from the group consisting of Zn, Al, Ga, Si, Ge, Sn, As, Ti, Mo, W, Fe, Cr, and Co.

x satisfies 0≤x≤1.0, and particularly satisfies 0≤x≤0.2.

y satisfies 0≤y≤1.0, and particularly satisfies 0.20≤y≤0.50.

a is an average valence of A. The average valence of A is, for example, a value represented by (n1×a+n2×b+n3×c)/(n1+n2+n3) in a case where the number of elements X having a valence of a+ is n1, the number of elements Y having a valence of b+ is n2, and the number of elements Z having a valence of c+ is n3 in the elements represented by A.

c is an average valence of D. The average valence of D is, for example, the same value as the above-described average valence of A in a case where the number of elements X having a valence of a+ is n1, the number of elements Y having a valence of b+ is n2, and the number of elements Z having a valence of c+ is n3 in the elements represented by D.

Specific examples of the solid electrolytes having a γ-Li₃VO₄ structure include Li_{3.2} (V_{0.8}Si_{0.2})O₄, Li_{3.5} (V_{0.5}Ge_{0.5})O₄, Li_{3.4}(P_{0.6}Si_{0.4})O₄, and Li_{3.5}(P_{0.5}Ge_{0.5})O₄.

An oxide glass ceramic-based lithium ion conductor can be used such as a phosphate compound (LATP) containing lithium, aluminum, and titanium as constituent elements or a phosphate compound (LAGP) containing lithium, aluminum, and germanium as constituent elements.

The solid electrolyte layer may further include, for example, a sintering aid and the like in addition to the solid electrolyte.

As the sintering aid in the solid electrolyte layer, the same compound as the sintering aid in the positive electrode layer can be used.

The volume percentage of the sintering aid in the solid electrolyte layer is not particularly limited, and is preferably 0% to 20%, and more preferably 1% to 10%, from the viewpoints of more excellent ion conductivity and more sufficient suppression of an increase in electron conductivity at the time of operation.

The thickness of the solid electrolyte layer is usually 0.1 to 30 μm, and is preferably 1 to 20 μm from the viewpoints of more excellent ion conductivity and more sufficient suppression of an increase in electron conductivity at the time of operation. As the thickness of the solid electrolyte layer, the average of thicknesses measured at any 10 points in a SEM image is used.

The porosity of the solid electrolyte layer is not particularly limited, and is preferably 20% or less, more preferably 15% or less, and still more preferably 10% or less from the viewpoints of more excellent ion conductivity and more sufficient suppression of an increase in electron conductivity at the time of operation.

As the porosity of the solid electrolyte layer, a value is used that is measured with the same method as the porosity of the positive electrode layer.

### [Method of Producing Solid-State Battery]

The solid-state battery can be produced, for example, with a so-called green sheet method, a printing method, or a combined method thereof.

The green sheet method will be described.

First, a solvent, a binder, and the like are appropriately mixed with a positive electrode active material to prepare a paste. The paste is applied onto a sheet, and dried to form a first green sheet for formation of a positive electrode layer. The first green sheet may include a solid electrolyte, a conductive material, and/or, for example, a sintering aid.

A solvent, a binder, and the like are appropriately mixed with a negative electrode active material to prepare a paste. The paste is applied onto a sheet, and dried to form a second green sheet for formation of a negative electrode layer. The second green sheet may include a solid electrolyte, a conductive material, and/or, for example, a sintering aid.

A solvent, a binder, and the like are appropriately mixed with a solid electrolyte to prepare a paste. The paste is applied and dried to prepare a third green sheet for formation of a solid electrolyte layer. The third green sheet may include a sintering aid and the like.

The solvent for preparation of the first to the third green sheets is not particularly limited, and for example, a solvent is used that may be used for producing a positive electrode layer, a negative electrode layer, or a solid electrolyte layer in the field of solid-state batteries. As the solvent, a solvent is usually used in which the binder described below can be used. Examples of such a solvent include alcohols such as 2-propanol.

The binder for preparation of the first to the third green sheets is not particularly limited, and for example, a binder is used that may be used for producing a positive electrode layer, a negative electrode layer, or a solid electrolyte layer in the field of solid-state batteries. Examples of such a binder include a butyral resin and an acrylic resin.

Next, the first to the third green sheets are appropriately stacked to prepare a laminate. The prepared laminate may be pressed. Examples of a preferable pressing method include an isostatic pressing method.

Thereafter, the laminate is sintered at, for example, 600 to 800° C., and thus a solid-state battery can be obtained.

The printing method will be described.

The printing method is the same as the green sheet method except for the following matters.

An ink for each layer is prepared so as to have the same composition as the paste for each layer prepared to obtain a green sheet, except that the amounts of the solvent and the resin blended are set to be suitable for use as an ink.

The ink for each layer is used for printing and stacking to prepare a laminate.

The present disclosure as described above encompasses the following preferable aspects.

<1> A solid electrolyte ceramic having a chemical composition represented by:

AₐB_{β}(D¹+D²)_{γ}O_{ω} (I)
wherein A represents one or more elements selected from Li, Ga, Al, Mg, Zn, and Sc, and A including at least Li;
B represents one or more elements selected from La, Ca, Sr, Ba, and lanthanoid elements, and B including at least La;
D¹ and D² represent one or more elements selected from transition elements capable of being six-coordinate with oxygen and elements belonging to Groups 12 to 15, D¹ represents one or more elements selected from Ta, Nb, and Bi;
5.0≤α≤8.0;
2.5≤β≤3.5;
1.5≤γ≤2.5; and
11≤ω≤13; and
one or more transition metal elements selected from Co, Ni, Mn, and Fe,
the solid electrolyte ceramic having a garnet-type crystal structure where:
10≤Y≤70 in a range of 220<X≤245
wherein X (mol %) represents a content of the Li and Y (mol %) represents a content of the one or more elements represented by D¹ when a content of the one or more elements represented by B is 100 mol %.

<2> The solid electrolyte ceramic according to <1>, wherein the one or more elements represented by D¹ include bismuth (Bi).

<3> The solid electrolyte ceramic according to <2>, wherein a content of the Bi is 0.1 mol % to 30 mol % when the content of the one or more elements represented by B is 100 mol %.

<4> The solid electrolyte ceramic according to any one of <1> to <3>, wherein the one or more elements represented by D¹ include tantalum (Ta).

<5> The solid electrolyte ceramic according to <4>, wherein a content of the Ta is 1 mol % to 80 mol % when the content of the one or more elements represented by B is 100 mol %.

<6> The solid electrolyte ceramic according to any one of <1> to <5>, wherein the one or more elements represented by D² include or do not include zirconium (Zr).

<7> The solid electrolyte ceramic according to <6>, wherein a content of the Zr is 0 mol % to 70 mol % when the content of the one or more elements represented by B is 100 mol %.

<8> The solid electrolyte ceramic according to any one of <1> to <7>, wherein a content of the one or more transition metal elements is 0.01 mol % to 10 mol % when the content of the one or more elements represented by B is 100 mol %.

<9> The solid electrolyte ceramic according to any one of <1> to <8>, wherein the one or more transition metal elements include one or more elements selected from the group consisting of Co and Mn.

<10> The solid electrolyte ceramic according to any one of <1> to <9>, wherein the one or more transition metal elements include Co.

<11> A solid-state battery including the solid electrolyte ceramic according to any one of <1> to <10>.

<12> The solid-state battery according to <11>, including a positive electrode layer, a negative electrode layer, and a solid electrolyte layer layered between the positive electrode layer and the negative electrode layer, wherein the positive electrode layer and the negative electrode layer are capable of occluding and releasing lithium ions.

<13> The solid-state battery according to <12>, wherein the solid electrolyte layer is an integrally sintered layer with the positive electrode layer and the negative electrode layer.

<14> The solid-state battery according to any one of <11> to <13>, wherein the solid electrolyte ceramic is included in the solid electrolyte layer of the solid-state battery.

Hereinafter, the present disclosure will be described in more detail on the basis of specific examples, but the present disclosure is not limited to the following examples and can be appropriately changed and implemented without changing the gist of the present disclosure.

### EXAMPLES

### Examples 1 to 15 and Comparative Examples 1 to 3

### [Production of Solid Electrolyte Ceramic]

As starting materials, lithium hydroxide monohydrate LiOH·H₂O, lanthanum hydroxide La(OH)₃, zirconium oxide ZrO₂, tantalum oxide Ta₂O₅, bismuth oxide Bi₂O₃, cobalt oxide Co₃O₄, basic nickel carbonate hydrate NiCo₃·2Ni(OH)₂·4H₂O, manganese carbonate MnCo₃, and iron oxide Fe₂O₃ were used.

Each starting material was weighed out so as to provide each chemical composition in Table 1.

Water was added, the resulting mixture was enclosed in a polyethylene polypot, and the polypot was rotated on a pot rack at 150 rpm for 16 hours to mix the starting materials.

The obtained slurry was evaporated and dried, and then calcined in O₂ at 900° C. for 5 hours to obtain a target phase.

A mixed solvent of toluene-acetone was added to the obtained calcined powder, and the resulting mixture was ground for 12 hours with a planetary ball mill. The ground powder was confirmed to have no compositional deviation by ICP measurement. The ground powder at this time had an average particle size of 150 nm.

### [Production of Solid Electrolyte Single Plate]

As a sample for evaluation of a solid electrolyte ceramic, a solid electrolyte single plate was produced with the following method.

The obtained solid electrolyte powder, a butyral resin, and an alcohol were kneaded at a weight ratio of 200:15:140 to produce a slurry.

The slurry was formed into a sheet on a PET film using a doctor blade method to obtain a sheet. The prepared sheets were stacked until the thickness of the sheets reached 200 μm, and then cut into a square shape having a size of 10 mm×10 mm, the binder was removed at 400° C., and then the sheets were subjected to press sintering at 850 to 950° C. for 60 to 600 minutes under a pressure of 100 MPa to produce a solid electrolyte single plate. The porosity of the solid electrolyte single plate was 10% or less, and sufficient progress of the sintering was confirmed. The surface of the obtained sintered body was polished to obtain a garnet solid electrolyte substrate.

### [Crystal Structure of Solid Electrolyte Single Plate]

In all Examples and Comparative Examples, X-ray diffraction of the solid electrolyte single plate was performed to confirm that an X-ray diffraction image was obtained that was to be assigned to a pseudo-garnet-type crystal structure (ICDD Card No. 00-045-0109).

### [Chemical Composition of Solid Electrolyte Single Plate]

The solid electrolyte single plate was subjected to ICP analysis to obtain the average chemical composition of the solid electrolyte single plate. The contents of Li, La, Ta, Zr, and Bi and the content of Co, Mn, Ni, and Fe in the average chemical composition of the whole solid electrolyte single plate were determined as proportions with respect to the number of eight-coordination sites of the garnet-type crystal structure (for example, the total number of La and B¹ in the general formula (II) (that is, the content of the one or more elements represented by B in the general formula (I)) of 100 mol %, and shown in Tables. The value of oxygen (O) in the chemical composition is calculated so as to establish charge neutrality from the molar ratio and the valence of each element included in A, B, D¹, and D² in the general formula (I).

### [Measurement of Electron Conductivity]

Onto one side of the obtained single plate, an Au electrode was sputtered as a working electrode. To the other side, a Li metal having the same area as the Au electrode was attached. Finally, the cell was enclosed in a coin cell of the size 2035 to obtain an evaluation cell. All of the operations described above were performed in a dry room having a dew point of −40° C. or lower.

At room temperature, a voltage of 2 V relative to Li was applied to the working electrode, and the transient current was observed. The current flowing 10 hours after applying the voltage was read as a leakage current. From the leakage current, the electron conductivity was calculated using the following formula.

Electron conductivity=(I/V)×(L/A)
(I: leakage current, V: applied voltage, L: solid electrolyte single plate thickness, A: electrode area)
⊙: electron conductivity<1.0×10⁻⁸ S/cm (excellent);
◯: 1.0×10⁻⁸ S/cm≤electron conductivity<5.0×10⁻⁸ S/cm (good);
Δ: 5.0×10⁻⁸ S/cm≤electron conductivity<1.0×10⁻⁷ S/cm (acceptable) (no practical problem); and
X: 1.0×10⁻⁷ S/cm≤electron conductivity (not acceptable) (practical problem).

### [Measurement of Ion Conductivity]

On both sides of the solid electrolyte single plate, a gold (Au) layer to serve as a current collector layer was formed by sputtering, and then the resulting product was sandwiched and fixed by SUS current collectors. The sintered tablet of each solid electrolyte was subjected to alternate-current impedance measurement at room temperature (25° C.) in the range of 10 MHz to 0.1 Hz (±50 mV), and the ion conductivity was evaluated.
⊙: ion conductivity≥5.0×10⁻⁴ S/cm (no practical problem);
X: ion conductivity<5.0×10⁻⁴ S/cm (not acceptable) (practical problem).

### [Comprehensive Determination]

All of the results of evaluating the electron conductivity and the ion conductivity were comprehensively determined.
⊙: All of the results of evaluating the electron conductivity and the ion conductivity were ⊙.
◯: Among all of the results of evaluating the electron conductivity and the ion conductivity, the lowest evaluation result was ◯.
Δ: Among all of the results of evaluating the electron conductivity and the ion conductivity, the lowest evaluation result was Δ.
X: Among all of the results of evaluating the electron conductivity and the ion conductivity, the lowest evaluation result was X.

TABLE 1

| | | Li | B(La) | Ta | Zr | Bi | | Co/Ni/Mn |
|---|---|---|---|---|---|---|---|---|
| | | molar | molar | molar | molar | molar | D¹ molar | molar |
| | Chemical formula | ratio X * | ratio * | ratio * | ratio * | ratio * | ratio Y * | ratio |
| | A_{α}B_{β}(D¹ + D²)_{γ}O_{ω} | (%) | (%) | (%) | (%) | (%) | (%) | (%) |
| Example 1 | Li6.7La3Zr1.4Ta0.42Bi0.2 O12—Co0.05 | 224 | 100 | 14 | 47 | 6.7 | 20.7 | 1.67 |
| Example 2 | Li6.7La3Zr0.8Ta1Bi0.2 O12—Co0.05 | 224 | 100 | 33 | 27 | 6.7 | 40.0 | 1.67 |
| Example 3 | Li6.7La3Ta1.95Bi0.05 O12—Co0.05 | 224 | 100 | 65 | 0 | 1.7 | 66.7 | 1.67 |
| Example 4 | Li6.9La3Zr1.4Ta0.42Bi0.2 O12—Co0.05 | 231 | 100 | 14 | 47 | 6.7 | 20.7 | 1.67 |
| Example 5 | Li6.9La3Zr0.8Ta1Bi0.2 O12—Co0.05 | 231 | 100 | 33 | 27 | 6.7 | 40.0 | 1.67 |
| Example 6 | Li6.9La3Ta1.95Bi0.05 O12—Co0.05 | 231 | 100 | 65 | 0 | 1.7 | 66.7 | 1.67 |
| Example 7 | Li7.3La3Zr1.4Ta0.42Bi0.2 O12—Co0.05 | 242 | 100 | 14 | 47 | 6.7 | 20.7 | 1.67 |
| Example 8 | Li7.3La3Zr0.8Ta1Bi0.2 O12—Co0.05 | 242 | 100 | 33 | 27 | 6.7 | 40.0 | 1.67 |
| Example 9 | Li7.3La3Ta1.95Bi0.05 O12—Co0.05 | 242 | 100 | 65 | 0 | 1.7 | 66.7 | 1.67 |
| Example 10 | Li6.9La3Zr1.4Ta0.42Bi0.2 O12—Co0.005 | 231 | 100 | 14 | 47 | 6.7 | 20.7 | 0.17 |
| Example 11 | Li6.9La3Zr1.4Ta0.42Bi0.2 O12—Co0.001 | 231 | 100 | 14 | 47 | 6.7 | 20.7 | 0.03 |
| Example 12 | Li6.9La3Zr1.4Ta0.42Bi0.2 O12—Mn0.005 | 231 | 100 | 14 | 47 | 6.7 | 20.7 | 0.17 |
| Example 13 | Li6.9La3Zr1.4Ta0.42Bi0.2 O12—Mn0.001 | 231 | 100 | 14 | 47 | 6.7 | 20.7 | 0.03 |
| Example 14 | Li6.9La3Zr1.4Ta0.42Bi0.2 O12—Mi0.005 | 231 | 100 | 14 | 47 | 6.7 | 20.7 | 0.17 |
| Example 15 | Li6.9La3Zr1.4Ta0.42Bi0.2 O12—Mi0.001 | 231 | 100 | 14 | 47 | 6.7 | 20.7 | 0.03 |

| | | Electron | | Ion | |
|---|---|---|---|---|---|
| | Chemical formula | conductivity | | conductivity | Comprehensive |
| | A_{α}B_{β}(D¹ + D²)_{γ}O_{ω} | (S/cm) | Determination | determination | determination |
| Example 1 | Li6.7La3Zr1.4Ta0.42Bi0.2 O12—Co0.05 | 7 × 10⁻⁹ | ⊚ | ⊚ | ⊚ |
| Example 2 | Li6.7La3Zr0.8Ta1Bi0.2 O12—Co0.05 | 7 × 10⁻⁹ | ⊚ | ⊚ | ⊚ |
| Example 3 | Li6.7La3Ta1.95Bi0.05 O12—Co0.05 | 7 × 10⁻⁹ | ⊚ | ⊚ | ⊚ |
| Example 4 | Li6.9La3Zr1.4Ta0.42Bi0.2 O12—Co0.05 | 7 × 10⁻⁹ | ⊚ | ⊚ | ⊚ |
| Example 5 | Li6.9La3Zr0.8Ta1Bi0.2 O12—Co0.05 | 7 × 10⁻⁹ | ⊚ | ⊚ | ⊚ |
| Example 6 | Li6.9La3Ta1.95Bi0.05 O12—Co0.05 | 7 × 10⁻⁹ | ⊚ | ⊚ | ⊚ |
| Example 7 | Li7.3La3Zr1.4Ta0.42Bi0.2 O12—Co0.05 | 7 × 10⁻⁹ | ⊚ | ⊚ | ⊚ |
| Example 8 | Li7.3La3Zr0.8Ta1Bi0.2 O12—Co0.05 | 7 × 10⁻⁹ | ⊚ | ⊚ | ⊚ |
| Example 9 | Li7.3La3Ta1.95Bi0.05 O12—Co0.05 | 7 × 10⁻⁹ | ⊚ | ⊚ | ⊚ |
| Example 10 | Li6.9La3Zr1.4Ta0.42Bi0.2 O12—Co0.005 | 7 × 10⁻⁹ | ⊚ | ⊚ | ⊚ |
| Example 11 | Li6.9La3Zr1.4Ta0.42Bi0.2 O12—Co0.001 | 7 × 10⁻⁹ | ⊚ | ⊚ | ⊚ |
| Example 12 | Li6.9La3Zr1.4Ta0.42Bi0.2 O12—Mn0.005 | 1 × 10⁻⁸ | ◯ | ⊚ | ◯ |
| Example 13 | Li6.9La3Zr1.4Ta0.42Bi0.2 O12—Mn0.001 | 4 × 10⁻⁸ | ◯ | ⊚ | ◯ |
| Example 14 | Li6.9La3Zr1.4Ta0.42Bi0.2 O12—Mi0.005 | 5 × 10⁻⁸ | Δ | ⊚ | Δ |
| Example 15 | Li6.9La3Zr1.4Ta0.42Bi0.2 O12—Mi0.001 | 8 × 10⁻⁸ | Δ | ⊚ | Δ |

* Content with respect to content of B of 100 mol % in chemical formula

TABLE 2

| | | Li | B(La) | Ta | Zr | Bi | | Co/Ni/Mn |
|---|---|---|---|---|---|---|---|---|
| | | molar | molar | molar | molar | molar | D¹ molar | molar |
| | | ratio X * | ratio * | ratio * | ratio * | ratio * | ratio Y * | ratio |
| | Chemical formula | (%) | (%) | (%) | (%) | (%) | (%) | (%) |
| Comparative | Li6.6La3Zr1.4Ta0.4Bi0.2 O12—Co0.05 | 220 | 100 | 13 | 47 | 6.7 | 20.7 | 1.7 |
| Example 1 | | | | | | | | |
| Comparative | Li6.6La3Zr0.8Ta1Bi0.2 O12—Co0.05 | 220 | 100 | 33 | 27 | 6.7 | 40.0 | 1.7 |
| Example 2 | | | | | | | | |
| Comparative | Li6.6La3Ta1.95Bi0.05 O12—Co0.05 | 220 | 100 | 65 | 0 | 1.7 | 66.7 | 1.7 |
| Example 3 | | | | | | | | |

| | | Electron | | Ion | |
|---|---|---|---|---|---|
| | | conductivity | | conductivity | Comprehensive |
| | Chemical formula | (S/cm) | Determination | determination | determination |
| Comparative | Li6.6La3Zr1.4Ta0.4Bi0.2 O12—Co0.05 | 1 × 10⁻⁶ | X | ⊚ | X |
| Example 1 | | | | | |
| Comparative | Li6.6La3Zr0.8Ta1Bi0.2 O12—Co0.05 | 1 × 10⁻⁶ | X | ⊚ | X |
| Example 2 | | | | | |
| Comparative | Li6.6La3Ta1.95Bi0.05 O12—Co0.05 | 1 × 10⁻⁶ | X | ⊚ | X |
| Example 3 | | | | | |

* Content with respect to content of B of 100 mol % in chemical formula

From the comparison between Comparative Examples 1 to 3 and Examples 1 to 15, it is clear that in a case where the Li content is less than 220 mol, the electron conductivity is high and thus a possibility of a short-circuit is high.

From the comparison between Examples 1 to 13 and Examples 14 to 15, it is clear that if the solid electrolyte ceramic contains one or more elements selected from the group consisting of Co and Mn as one or more transition metal elements, excellent ion conductivity can be obtained and an increase in electron conductivity can be more sufficiently suppressed.

From the comparison between Examples 1 to 11 and Examples 12 to 15, it is clear that if the solid electrolyte ceramic contains Co as one or more transition metal elements, excellent ion conductivity can be obtained and an increase in electron conductivity can be still more sufficiently suppressed.

The solid-state battery including the solid electrolyte ceramic of the present disclosure can be used in various fields where battery use or power storage is assumed. The solid-state battery according to an embodiment of the present disclosure can be used in the field of electronics mounting, although merely an example. The solid-state battery according to an embodiment of the present disclosure can also be used in the fields of electricity, information, and communication in which mobile devices and the like are used (for example, the fields of electrical/electronic devices and mobile devices including small electronic machines such as mobile phones, smartphones, smartwatches, notebook computers, digital cameras, activity meters, arm computers, electronic paper, wearable devices, RFID tags, card type electronic money, and smartwatches), home and small industrial applications (for example, the fields of electric tools, golf carts, and home, nursing, and industrial robots), large industrial applications (for example, the fields of forklifts, elevators, and harbor cranes), transportation system fields (for example, the fields of hybrid vehicles, electric vehicles, buses, trains, power-assisted bicycles, electric two-wheeled vehicles), power system applications (for example, the fields of various types of power generation, road conditioners, smart grids, and household power storage systems), medical applications (the field of medical devices such as earphone hearing aids), pharmaceutical applications (the fields of dosage management systems and the like), IoT fields, space and deep sea applications (for example, the fields of space probes and submersibles), and the like.

1. A solid electrolyte ceramic comprising:
a chemical composition represented by:
A_{α}B_{β}(D¹+D²)_{γ}O_{ω} (I)
wherein A represents one or more elements selected from Li, Ga, Al, Mg, Zn, and Sc, and A including at least Li;
B represents one or more elements selected from La, Ca, Sr, Ba, and lanthanoid elements, and B including at least La;
D¹ and D² represent one or more elements selected from transition elements capable of being six-coordinate with oxygen and elements belonging to Groups 12 to 15, D¹ represents one or more elements selected from Ta, Nb, and Bi, and D¹ including at least Bi;
5.0≤α≤8.0;
2.5≤β≤3.5;
1.5≤γ≤2.5; and
11≤ω≤13; and
one or more transition metal elements selected from Co, Ni, Mn, and Fe,
the solid electrolyte ceramic having a garnet-type crystal structure where: 10≤Y≤70 in a range of 220<x≤245,
wherein X (mol %) represents a content of the Li and Y (mol %) represents a content of the one or more elements represented by D¹ when a content of the one or more elements represented by B is 100 mol %.

2. The solid electrolyte ceramic according to claim 1, wherein a content of the Bi is 0.1 mol % to 30 mol % when the content of the one or more elements represented by B is 100 mol %.

3. The solid electrolyte ceramic according to claim 1, wherein the one or more elements represented by D¹ include Ta.

4. The solid electrolyte ceramic according to claim 3, wherein a content of the Ta is 1 mol % to 80 mol % when the content of the one or more elements represented by B is 100 mol %.

5. The solid electrolyte ceramic according to claim 1, wherein the one or more elements represented by D² include Zr.

6. The solid electrolyte ceramic according to claim 5, wherein a content of the Zr is greater than 0 mol % to 70 mol % when the content of the one or more elements represented by B is 100 mol %.

7. The solid electrolyte ceramic according to claim 1, wherein the one or more elements represented by D² do not include Zr.

8. The solid electrolyte ceramic according to claim 1, wherein the one or more elements represented by D² do not include Ta, Nb, and Bi.

9. The solid electrolyte ceramic according to claim 1, wherein the chemical composition is one of:
Li_{6.7}La₃Zr_{1.4}Ta_{0.42}Bi_{0.2}O₁₂—Co_{0.05};
Li_{6.7}La₃Zr_{0.8} Ta₁Bi_{0.2}O₁₂—Co_{0.05};
Li_{6.7}La₃Ta_{1.95}Bi_{0.05}O₁₂—Co_{0.05};
Li_{6.9}La₃Zr_{1.4}Ta_{0.42}Bi_{0.2}O₁₂—Co_{0.05};
Li_{6.9}La₃Zr_{0.8}Ta₁Bi_{0.2}O₁₂—Co_{0.05};
Li_{6.9}La₃Ta_{1.95}Bi_{0.05}O₁₂—Co_{0.05};
Li_{7.3}La₃Zr_{1.4}Ta_{0.42}Bi_{0.2}O₁₂—Co_{0.05};
Li_{7.3}La₃Zr_{0.8}Ta₁Bi_{0.2}O₁₂—Co_{0.05};
Li_{7.3}La₃Ta_{1.95}Bi_{0.05}O₁₂—Co_{0.05};
Li_{6.9}La₃Zr_{1.4}Ta_{0.42}Bi_{0.2}O₁₂—Co_{0.005};
Li_{6.9}La₃Zr_{1.4}Ta_{0.42}Bi_{0.2}O₁₂—Co_{0.001};
Li_{6.9}La₃Zr_{1.4} Ta_{0.42}Bi_{0.2}O₁₂—Mn_{0.005};
Li_{6.9}La₃Zr_{1.4} Ta_{0.42}Bi_{0.2}O₁₂—Mn_{0.001};
Li_{6.9}La₃Zr_{1.4} Ta_{0.42}Bi_{0.2}O₁₂—Ni_{0.005}; and
Li_{6.9}La₃Zr_{1.4}Ta_{0.42}Bi_{0.2}O₁₂—Ni_{0.001}.

10. The solid electrolyte ceramic according to claim 1, wherein a content of the one or more transition metal elements is 0.01 mol % to 10 mol % when the content of the one or more elements represented by B is 100 mol %.

11. The solid electrolyte ceramic according to claim 1, wherein the one or more transition metal elements include one or more elements selected from Co and Mn.

12. The solid electrolyte ceramic according to claim 1, wherein the one or more transition metal elements include Co.

13. A solid-state battery comprising the solid electrolyte ceramic according to claim 1.

14. The solid-state battery according to claim 13, further comprising:
a positive electrode layer;
a negative electrode layer; and
a solid electrolyte layer layered between the positive electrode layer and the negative electrode layer, wherein
the positive electrode layer and the negative electrode layer are capable of occluding and releasing lithium ions.

15. The solid-state battery according to claim 14, wherein the solid electrolyte layer is an integrally sintered layer with the positive electrode layer and the negative electrode layer.

16. The solid-state battery according to claim 11, wherein the solid electrolyte ceramic is included in the solid electrolyte layer of the solid-state battery.
